(19) United States
(12) Patent Application Publication
(10) Pub. No.: US 2019/0126312 A1
(43) Pub. Date: May 2, 2019

(54) IN-LINE MIXING OF NANOSTRUCTURE PREMIXES FOR REAL-TIME WHITE POINT ADJUSTMENT

(71) Applicant: Nanosys, Inc., Milpitas, CA (US)

(72) Inventors: James KUNDRAT, Newark, CA (US); David OLMEIJER, San Francisco, CA (US); David STRAIT, Mountain View, CA (US); Poching TSAI, Newark, CA (US)

(73) Assignee: Nanosys, Inc., Milpitas, CA (US)

(21) Appl. No.: 16/175,897

(22) Filed: Oct. 31, 2018

Related U.S. Application Data
(60) Provisional application No. 62/579,923, filed on Nov. 1, 2017.

(51) Int. Cl. B05C 1/08; C09D 133/06; C09D 5/22; B05D 1/28; B05C 11/10

(52) U.S. Cl. CPC B05C 1/08; C09D 133/06; B82Y 40/00; B05D 1/28; B05C 11/1002; C09D 5/22

(57) ABSTRACT

The present invention provides a method of producing nanostructure compositions and nanostructure films. The method includes adjusting white point of the nanostructure films in a continuous process. The present invention also provides an apparatus for preparing a nanostructure film for real-time white point adjustment.

### BACKGROUND OF THE INVENTION

### Field of the Invention

This invention relates to nanostructure materials, nanostructure films and processes for their manufacture.

### Background Art

Nanostructures can be incorporated into a variety of electronic and optical devices. The electrical and optical properties of such nanostructures vary, e.g., depending on their composition, shape, and size. For example, size-tunable properties of semiconductor nanoparticles are of great interest for applications such as light emitting diodes (LEDs), lasers, and biomedical labeling. Highly luminescent nanostructures are particularly desirable for such applications.

To exploit the full potential of nanostructures in applications such as LEDs and displays, the nanostructures need to simultaneously meet five criteria: narrow and symmetric emission spectra, high photoluminescence (PL) quantum yields (QYs), high optical stability, eco-friendly materials, and low-cost methods for mass production.

Inorganic shell coatings on quantum dots are a universal approach to tailoring their electronic structure. Additionally, deposition of an inorganic shell can produce more robust particles by passivation of surface defects. Ziegler, J., et al., Adv. Mater. 20:4068-4073 (2008). For example, shells of wider band gap semiconductor materials such as ZnS can be deposited on a core with a narrower band gap—such as CdSe or InP—to afford structures in which excitons are confined within the core. This approach increases the probability of radiative recombination and makes it possible to synthesize very efficient quantum dots with quantum yields close to unity and thin shell coatings.

Luminescent nanostructures can be used to manufacture nanostructure films that are used in displays and other optical components (optical construction). Luminescent nanocrystals represent a new, alternative class of phosphors often used in configurations where the phosphor may be placed external to the LEDs. Light emanating from the LEDs may be processed through a phosphor film of the display device to produce white light, which may be distributed across a display screen of the display device.

For example, luminescent nanocrystals may be embedded in a flexible film/sheet (e.g., quantum dot enhancement film (QDEF®) supplied commercially from 3M Company, St. Paul, Minn. using quantum dots supplied by Nanosys, Inc, Milpitas, Calif.) that may be placed in a display device (see, e.g., U.S. Patent Publication Nos. 2010/0110728 and 2012/0113672). In other examples, luminescent nanocrystals may be encapsulated in a container, for example a capillary (see, e.g., U.S. Patent Publication No. 2010/0110728).

In current display devices using QDEFs, the white point values of the light distributed across display screens depend on the nanostructure population size in the QDEFs. The nanostructure population size can be adjusted by changing the concentration of nanostructures in the QDEF and/or changing the thickness of the QDEF. Furthermore, reducing the nanostructure population size in order to achieve a given white point can reduce the cost of display devices using QDEF.

QDEFs can be constructed by incorporating nanostructures into a curable resin matrix and coating the nanostructure mixture onto optical grade substrates. The white point of the film is determined by the concentration and emission wavelengths of green and red nanostructures in the resin. Predicting the white point of the final film can be tedious and often requires several rounds of formulation and testing to achieve desired results.

Therefore, a need exists for developing a system for quick and efficient white point adjustment of nanostructure film.

### BRIEF SUMMARY OF THE INVENTION

The invention provides a method and system to manufacture nanostructure compositions, nanostructure films and make adjustments to the white point of the nanostructure films in real time during coating process.

In some embodiments, the present invention provides a method of preparing a nanostructure composition, comprising:

(a) providing at least two nanostructure premixes, wherein each nanostructure premix comprising at least one population of nanostructures and at least one organic resin;

(b) continuously delivering the at least two nanostructure premixes to a mixing apparatus to give a nanostructure composition;

(c) coating the nanostructure composition onto a substrate to make a nanostructure film;

(d) continuously monitoring an optical property of the nanostructure film; and

(e) adjusting the quantity of the at least two nanostructure premixes delivered to the mixing apparatus thereby adjusting the optical property of the nanostructure film.

In some embodiments, the method further comprises admixing a blank resin with the at least two nanostructure premixes, wherein the blank resin comprises at least one organic resin.

In some embodiments, the at least one population of nanostructures and the at least one organic resin are premixed to make the nanostructure premix prior to the continuously delivering in (b).

In some embodiments, the nanostructure premix is stored for 1 hour to 1 year, 1 hour to 1 month, 1 hour to 1 week, or for 12 hours to 2 days, or for 24 hours, prior to the continuously delivering in (b).

In some embodiments, the stored nanostructure premix is remixed within 4 hours, or within 2 hours, or within 1 hour, prior to the continuously delivering in (b).

In some embodiments, the at least one nanostructure premix comprises a red nanostructure premix and a green nanostructure premix.

In some embodiments, the at least one nanostructure premix further comprises a blue nanostructure premix.

In some embodiments, the nanostructure premix comprises between one and five populations of nanostructures.

In some embodiments, the at least one population of nanostructures contain a core selected from the group consisting of InP and CdSe.

In some embodiments, the nanostructures are core/shell nanostructures.

In some embodiments, the core/shell nanostructures are CdSe/ZnSe/ZnS or InP/ZnSe/ZnS nanostructures.

In some embodiments, the at least one organic resin comprises between one and five organic resins.

In some embodiments, the at least one organic resin comprises tricyclodecane dimethanol diacrylate, pentaerythritol tetrakis(3-mercaptopropionate), trimethylolpropane tris(3-mercaptopropionate), tris[2-(3-mercaptopropionyloxy)ethyl]isocyanurate, ethylene glycol diethanethiol, glycol di(3-mercaptopriopionate), triallyl triazine trione, tris[2-(acryloyloxy)ethyl]isocyanurate, cyclohexane dimethanol di(meth)acrylate, hexanediol di(meth)acrylate, butanediol di(meth)acrylate, trimethanolpropane tri(meth)acrylate, pentaerythritol tetra(meth)acrylate, triallyl cyanurate, trivinylcyclohexane, pentaerythritol allyl ether, cyclohexanedimethanol divinyl ether, butanediol divinyl ether, isobornyl (meth)acrylate, lauryl (meth)acrylate, bisphenol A ethoxylate di(meth)acrylate, 2-carboxyethyl (meth)acrylate, 2-hydroxyethyl (meth)acrylate, 2-((meth)acryloyloxy) ethyl phosphate, furfuryl (meth)acrylate, or oligomerization products thereof.

In some embodiments, the nanostructure premix further comprises a surfactant, a solvent, a humectant, or a viscosity modifier.

In some embodiments, the optical property is white point, color gamut, optical density, emission wavelengths, FWHM, and/or brightness.

In some embodiments, the optical property is monitored with a spectrometer.

In some embodiments, the nanostructures are quantum dots.

In some embodiments, the present invention provides an apparatus for preparing a nanostructure film, comprising:

(a) a mixing apparatus;

(b) at least two input ports fluidly connected to the mixing apparatus;

(c) a coating system; and

(d) an instrument that measures an optical property of the nanostructure film.

In some embodiments, the at least two input ports comprise three input ports.

In some embodiments, the at least two input ports are metering pumps.

In some embodiments, the at least two input ports are syringe pumps.

In some embodiments, the at least two input ports are flow controlled.

In some embodiments, the mixing apparatus is a static mixer.

In some embodiments, the coating system is a roll-to-roll coating system.

In some embodiments, the instrument that measures an optical property of the nanostructure film is a spectrometer.

In some embodiments, the spectrometer is capable of measuring ultraviolet-visible light.

### BRIEF DESCRIPTION OF THE DRAWINGS

FIG. 1 depicts a scheme for a coating line configured for monitoring the optical property of nanostructures in a film.

FIGS. 2A-2B are line graphs showing the power (%) versus hours. For sample 1, poorly dispersed red nanostructures gave reduced light box reliability (FIG. 2A). For sample 2, fully dispersed control sample gave good light box reliability (FIG. 2B).

### DETAILED DESCRIPTION OF THE INVENTION

### Definitions

Unless defined otherwise, all technical and scientific terms used herein have the same meaning as commonly understood by one of ordinary skill in the art to which the invention pertains. The following definitions supplement those in the art and are directed to the current application and are not to be imputed to any related or unrelated case, e.g., to any commonly owned patent or application. Although any methods and materials similar or equivalent to those described herein can be used in the practice for testing of the present invention, the preferred materials and methods are described herein. Accordingly, the terminology used herein is for the purpose of describing particular embodiments only, and is not intended to be limiting.

As used in this specification and the appended claims, the singular forms “a,” “an” and “the” include plural referents unless the context clearly dictates otherwise. Thus, for example, reference to “a nanostructure” includes a plurality of such nanostructures, and the like.

The term “about” as used herein indicates the value of a given quantity varies by ±10% of the value. For example, “about 100 nm” encompasses a range of sizes from 90 nm to 110 nm, inclusive.

A “nanostructure” is a structure having at least one region or characteristic dimension with a dimension of less than about 500 nm. In some embodiments, the nanostructure has a dimension of less than about 200 nm, less than about 100 nm, less than about 50 nm, less than about 20 nm, or less than about 10 nm. Typically, the region or characteristic dimension will be along the smallest axis of the structure. Examples of such structures include nanowires, nanorods, nanotubes, branched nanostructures, nanotetrapods, tripods, bipods, nanocrystals, nanodots, quantum dots, nanoparticles, and the like. Nanostructures can be, e.g., substantially crystalline, substantially monocrystalline, polycrystalline, amorphous, or a combination thereof. In some embodiments, each of the three dimensions of the nanostructure has a dimension of less than about 500 nm, less than about 200 nm, less than about 100 nm, less than about 50 nm, less than about 20 nm, or less than about 10 nm.

The term “heterostructure” when used with reference to nanostructures refers to nanostructures characterized by at least two different and/or distinguishable material types. Typically, one region of the nanostructure comprises a first material type, while a second region of the nanostructure comprises a second material type. In certain embodiments, the nanostructure comprises a core of a first material and at least one shell of a second (or third etc.) material, where the different material types are distributed radially about the long axis of a nanowire, a long axis of an arm of a branched nanowire, or the center of a nanocrystal, for example. A shell can but need not completely cover the adjacent materials to be considered a shell or for the nanostructure to be considered a heterostructure; for example, a nanocrystal characterized by a core of one material covered with small islands of a second material is a heterostructure. In other embodiments, the different material types are distributed at different locations within the nanostructure; e.g., along the major (long) axis of a nanowire or along a long axis of arm of a branched nanowire. Different regions within a heterostructure can comprise entirely different materials, or the different regions can comprise a base material (e.g., silicon) having different dopants or different concentrations of the same dopant.

As used herein, the “diameter” of a nanostructure refers to the diameter of a cross-section normal to a first axis of the nanostructure, where the first axis has the greatest difference in length with respect to the second and third axes (the second and third axes are the two axes whose lengths most nearly equal each other). The first axis is not necessarily the longest axis of the nanostructure; e.g., for a disk-shaped nanostructure, the cross-section would be a substantially circular cross-section normal to the short longitudinal axis of the disk. Where the cross-section is not circular, the diameter is the average of the major and minor axes of that cross-section. For an elongated or high aspect ratio nanostructure, such as a nanowire, the diameter is measured across a cross-section perpendicular to the longest axis of the nanowire. For a spherical nanostructure, the diameter is measured from one side to the other through the center of the sphere.

The terms “crystalline” or “substantially crystalline,” when used with respect to nanostructures, refer to the fact that the nanostructures typically exhibit long-range ordering across one or more dimensions of the structure. It will be understood by one of skill in the art that the term “long range ordering” will depend on the absolute size of the specific nanostructures, as ordering for a single crystal cannot extend beyond the boundaries of the crystal. In this case, “long-range ordering” will mean substantial order across at least the majority of the dimension of the nanostructure. In some instances, a nanostructure can bear an oxide or other coating, or can be comprised of a core and at least one shell. In such instances it will be appreciated that the oxide, shell(s), or other coating can but need not exhibit such ordering (e.g. it can be amorphous, polycrystalline, or otherwise). In such instances, the phrase “crystalline,” “substantially crystalline,” “substantially monocrystalline,” or “monocrystalline” refers to the central core of the nanostructure (excluding the coating layers or shells). The terms “crystalline” or “substantially crystalline” as used herein are intended to also encompass structures comprising various defects, stacking faults, atomic substitutions, and the like, as long as the structure exhibits substantial long range ordering (e.g., order over at least about 80% of the length of at least one axis of the nanostructure or its core). In addition, it will be appreciated that the interface between a core and the outside of a nanostructure or between a core and an adjacent shell or between a shell and a second adjacent shell may contain non-crystalline regions and may even be amorphous. This does not prevent the nanostructure from being crystalline or substantially crystalline as defined herein.

The term “monocrystalline” when used with respect to a nanostructure indicates that the nanostructure is substantially crystalline and comprises substantially a single crystal. When used with respect to a nanostructure heterostructure comprising a core and one or more shells, “monocrystalline” indicates that the core is substantially crystalline and comprises substantially a single crystal.

A “nanocrystal” is a nanostructure that is substantially monocrystalline. A nanocrystal thus has at least one region or characteristic dimension with a dimension of less than about 500 nm. In some embodiments, the nanocrystal has a dimension of less than about 200 nm, less than about 100 nm, less than about 50 nm, less than about 20 nm, or less than about 10 nm. The term “nanocrystal” is intended to encompass substantially monocrystalline nanostructures comprising various defects, stacking faults, atomic substitutions, and the like, as well as substantially monocrystalline nanostructures without such defects, faults, or substitutions. In the case of nanocrystal heterostructures comprising a core and one or more shells, the core of the nanocrystal is typically substantially monocrystalline, but the shell(s) need not be. In some embodiments, each of the three dimensions of the nanocrystal has a dimension of less than about 500 nm. In other embodiments, each of the dimensions of the nanocrystal has a dimension of less than about 200 nm, less than about 100 nm, less than about 50 nm, less than about 20 nm, or less than about 10 nm.

The term “quantum dot” (or “dot”) refers to a nanocrystal that exhibits quantum confinement or exciton confinement. Quantum dots can be substantially homogenous in material properties, or in certain embodiments, can be heterogeneous, e.g., including a core and at least one shell. The optical properties of quantum dots can be influenced by their particle size, chemical composition, and/or surface composition, and can be determined by suitable optical testing available in the art. The ability to tailor the nanocrystal size, e.g., in the range between about 1 nm and about 15 nm, enables photoemission coverage in the entire optical spectrum to offer great versatility in color rendering.

A “ligand” is a molecule capable of interacting (whether weakly or strongly) with one or more faces of a nanostructure, e.g., through covalent, ionic, van der Waals, or other molecular interactions with the surface of the nanostructure.

“Photoluminescence quantum yield” is the ratio of photons emitted to photons absorbed, e.g., by a nanostructure or population of nanostructures. As known in the art, quantum yield is typically determined by a comparative method using well-characterized standard samples with known quantum yield values.

As used herein, the term “shell” refers to material deposited onto the core or onto previously deposited shells of the same or different composition and that result from a single act of deposition of the shell material. The exact shell thickness depends on the material as well as the precursor input and conversion and can be reported in nanometers or monolayers. As used herein, “target shell thickness” refers to the intended shell thickness used for calculation of the required precursor amount. As used herein, “actual shell thickness” refers to the actually deposited amount of shell material after the synthesis and can be measured by methods known in the art. By way of example, actual shell thickness can be measured by comparing particle diameters determined from TEM images of nanocrystals before and after a shell synthesis.

As used herein, the term “full width at half-maximum” (FWHM) is a measure of the size distribution of nanostructures. The emission spectra of nanostructures generally have the shape of a Gaussian curve. The width of the Gaussian curve is defined as the FWHM and gives an idea of the size distribution of the particles. A smaller FWHM corresponds to a narrower nanostructure nanocrystal size distribution. FWHM is also dependent upon the emission wavelength maximum.

As used herein, the term “white point” or “white point value” refers to the color white in terms of a set of chromaticity coordinates, for example, u′ and v′ coordinates in CIE 1976 color space, where CIE stands for Commission Internationale de l'Eclairage (International Commission on Illumination). The relative mix of red and green nanostructures combined with their concentration and distribution in the film determines the white point of the film.

As used herein, “target value” refers to the intended value of the optical property for each intended application. By way of example, the relative proportion of red and green quantum dots is tuned to deliver a target value of white point (HDTV sRGB standard: u′=0.313, v′=0.329, Adobe RGB standard: u′=0.31, v′=0.33) in white LED display application. In some examples, the target value of color gamut as a percentage of the Rec.2020 space is about 80-100% in a white LED display application. In some examples, the target value of FWHM is between 15-50 nm. In some examples, the target value of optical density in the film is from 1 to 3 OD/ml/cm for green quantum dots and 0.5 to 2 OD/ml/cm for red quantum dots. In other examples, the target value of optical density is from 0 to 50 OD/ml/cm for both red and green quantum dots. In some examples, the target value of emission wavelengths is between 400-700 nm.

As used herein, the term “wind” or “wind roll” is meant to encompass a cylindrical roll that can be used to take up and wrap a pliable film, such as a plastic film or flexible glass. The term “unwind” or “unwind roll” is meant to encompass a cylindrical roll that can be used to uncoil a pliable film by unwinding from the roll, or to wind off.

As used herein, the term “conversion efficiency” is defined as (photons emitted/photons absorbed)*100.

Unless clearly indicated otherwise, ranges listed herein are inclusive.

A variety of additional terms are defined or otherwise characterized herein.

### Production of a Core

Methods for colloidal synthesis of a variety of nanostructures are known in the art. Such methods include techniques for controlling nanostructure growth, e.g., to control the size and/or shape distribution of the resulting nanostructures.

In a typical colloidal synthesis, semiconductor nanostructures are produced by rapidly injecting precursors that undergo pyrolysis into a hot solution (e.g., hot solvent and/or surfactant). The precursors can be injected simultaneously or sequentially. The precursors rapidly react to form nuclei. Nanostructure growth occurs through monomer addition to the nuclei, typically at a growth temperature that is lower than the injection/nucleation temperature.

Ligands interact with the surface of the nanostructure. At the growth temperature, the ligands rapidly adsorb and desorb from the nanostructure surface, permitting the addition and/or removal of atoms from the nanostructure while suppressing aggregation of the growing nanostructures. In general, a ligand that coordinates weakly to the nanostructure surface permits rapid growth of the nanostructure, while a ligand that binds more strongly to the nanostructure surface results in slower nanostructure growth. The ligand can also interact with one (or more) of the precursors to slow nanostructure growth.

Nanostructure growth in the presence of a single ligand typically results in spherical nanostructures. Using a mixture of two or more ligands, however, permits growth to be controlled such that non-spherical nanostructures can be produced, if, for example, the two (or more) ligands adsorb differently to different crystallographic faces of the growing nanostructure.

A number of parameters are thus known to affect nanostructure growth and can be manipulated, independently or in combination, to control the size and/or shape distribution of the resulting nanostructures. These include, e.g., temperature (nucleation and/or growth), precursor composition, time-dependent precursor concentration, ratio of the precursors to each other, surfactant composition, number of surfactants, and ratio of surfactant(s) to each other and/or to the precursors.

The synthesis of Group III-VI nanostructures has been described in U.S. Pat. Nos. 6,225,198, 6,322,901, 6,207,229, 6,607,829, 7,060,243, 7,374,824, 6,861,155, 7,125,605, 7,566,476, 8,158,193, and 8,101,234 and in U.S. Patent Appl. Publication Nos. 2011/0262752 and 2011/0263062. The synthesis of Group II-V nanostructures has been described in U.S. Pat. Nos. 5,505,928, 6,306,736, 6,576,291, 6,788,453, 6,821,337, and 7,138,098, 7,557,028, 8,062,967, 7,645,397, and 8,282,412 and in U.S. Patent Appl. Publication No. 2015/236195.

The synthesis of Group II-V nanostructures has also been described in Wells, R. L., et al., “The use of tris(trimethylsilyl)arsine to prepare gallium arsenide and indium arsenide,” Chem. Mater. 1:4-6 (1989) and in Guzelian, A. A., et al., “Colloidal chemical synthesis and characterization of InAs nanocrystal quantum dots,” Appl. Phys. Lett. 69: 1432-1434 (1996).

Synthesis of InP-based nanostructures has been described, e.g., in Xie, R., et al., “Colloidal InP nanocrystals as efficient emitters covering blue to near-infrared,” J. Am. Chem. Soc. 129:15432-15433 (2007); Micic, O. I., et al., “Core-shell quantum dots of lattice-matched ZnCdSe₂ shells on InP cores: Experiment and theory,” J. Phys. Chem. B 104:12149-12156 (2000); Liu, Z., et al., “Coreduction colloidal synthesis of II-V nanocrystals: The case of InP,” Angew. Chem. Int. Ed. Engl. 47:3540-3542 (2008); Li, L. et al., “Economic synthesis of high quality InP nanocrystals using calcium phosphide as the phosphorus precursor,” Chem. Mater. 20:2621-2623 (2008); D. Battaglia and X. Peng, “Formation of high quality InP and InAs nanocrystals in a noncoordinating solvent,” Nano Letters 2:1027-1030 (2002); Kim, S., et al., “Highly luminescent InP/GaP/ZnS nanocrystals and their application to white light-emitting diodes,” J. Am. Chem. Soc. 134:3804-3809 (2012); Nann, T., et al., “Water splitting by visible light: A nanophotocathode for hydrogen production,” Angew. Chem. Int. Ed. 49:1574-1577 (2010); Borchert, H., et al., “Investigation of ZnS passivated InP nanocrystals by XPS,” Nano Letters 2:151-154 (2002); L. Li and P. Reiss, “One-pot synthesis of highly luminescent InP/ZnS nanocrystals without precursor injection,” J. Am. Chem. Soc. 130:11588-11589 (2008); Hussain, S., et al. “One-pot fabrication of high-quality InP/ZnS (core/shell) quantum dots and their application to cellular imaging,” Chemphyschem. 10:1466-1470 (2009); Xu, S., et al., “Rapid synthesis of high-quality InP nanocrystals,” J. Am. Chem. Soc. 128:1054-1055 (2006); Micic, O. I., et al., “Size-dependent spectroscopy of InP quantum dots,” J. Phys. Chem. B 101:4904-4912 (1997); Haubold, S., et al., “Strongly luminescent InP/ZnS core-shell nanoparticles,” Chemphyschem. 5:331-334 (2001); CrosGagneux, A., et al., “Surface chemistry of InP quantum dots: A comprehensive study,” J. Am. Chem. Soc. 132:18147-18157 (2010); Micic, O. I., et al., “Synthesis and characterization of InP, GaP, and GaInP₂ quantum dots,” J. Phys. Chem. 99:7754-7759 (1995); Guzelian, A. A., et al., “Synthesis of size-selected, surface-passivated InP nanocrystals,” J. Phys. Chem. 100:7212-7219 (1996); Lucey, D. W., et al., “Monodispersed InP quantum dots prepared by colloidal chemistry in a non-coordinating solvent,” Chem. Mater. 17:3754-3762 (2005); Lim, J., et al., “InP@ZnSeS, core@composition gradient shell quantum dots with enhanced stability,” Chem. Mater. 23:4459-4463 (2011); and Zan, F., et al., “Experimental studies on blinking behavior of single InP/ZnS quantum dots: Effects of synthetic conditions and UV irradiation,” J. Phys. Chem. C 116:394-3950 (2012).

In some embodiments, the core is a Group II-VI nanocrystal selected from the group consisting of ZnO, ZnSe, ZnS, ZnTe, CdO, CdSe, CdS, CdTe, HgO, HgSe, HgS, HgTe, perovskite, and CuInₓGa₁₋ₓS_{y}Se_{2-y}. In some embodiments, the core is a nanocrystal selected from the group consisting of ZnSe, ZnS, CdSe, and CdS.

In some embodiments, the at least one first core is a cadmium-containing nanostructure and an at least one second core is a Group II-VI nanostructure. In some embodiments, the second core is a Group II-VI nanocrystal selected from the group consisting of BN, BP, BAs, AlN, AlP, AlAs, AlSb, GaN, GaP, GaAs, GaSb, InN, InP, InAs, InSb, perovskite, and CuInₓGa₁₋ₓS_{y}Se_{2-y}. In some embodiments, the at least one second core is an InP nanocrystal.

In some embodiments, the core is doped. In some embodiments, the dopant of the nanocrystal core comprises a metal, including one or more transition metals. In some embodiments, the dopant is a transition metal selected from the group consisting of Ti, Zr, Hf, V, Nb, Ta, Cr, Mo, W, Mn, Tc, Re, Fe, Ru, Os, Co, Rh, Ir, Ni, Pd, Pt, Cu, Ag, Au, and combinations thereof. In some embodiments, the dopant comprises a non-metal. In some embodiments, the dopant is ZnS, ZnSe, ZnTe, CdSe, CdS, CdTe, HgS, HgSe, HgTe, CuInS₂, CuInSe₂, AlN, AlP, AlAs, GaN, GaP, or GaAs.

In some embodiments, the core is purified before deposition of a shell. In some embodiments, the core is filtered to remove precipitate from the core solution.

In some embodiments, the core is subjected to an acid etching step before deposition of a shell.

In some embodiments, the diameter of the core is determined using quantum confinement. Quantum confinement in zero-dimensional nanocrystallites, such as quantum dots, arises from the spatial confinement of electrons within the crystallite boundary. Quantum confinement can be observed once the diameter of the material is of the same magnitude as the de Broglie wavelength of the wave function. The electronic and optical properties of nanoparticles deviate substantially from those of bulk materials. A particle behaves as if it were free when the confining dimension is large compared to the wavelength of the particle. During this state, the bandgap remains at its original energy due to a continuous energy state. However, as the confining dimension decreases and reaches a certain limit, typically in nanoscale, the energy spectrum becomes discrete. As a result, the bandgap becomes size-dependent.

### Production of a Shell

In some embodiments, the nanostructures include a core and at least one shell. In some embodiments, the nanostructures include a core and at least two shells. The shell can, e.g., increase the quantum yield and/or stability of the nanostructures. In some embodiments, the core and the shell comprise different materials. In some embodiments, the nanostructure comprises shells of different shell material.

In some embodiments, shell material is deposited onto a core or a core/shell(s) that comprises a mixture of Group II and VI materials. In some embodiments, the shell material comprises at least two of a zinc source, a selenium source, a sulfur source, a tellurium source, and a cadmium source. In some embodiments, the shell material comprises two of a zinc source, a selenium source, a sulfur source, a tellurium source, and a cadmium source. In some embodiments, the shell material comprises three of a zinc source, a selenium source, a sulfur source, a tellurium source, and a cadmium source. In some embodiments, the shell material deposited is ZnS, ZnSe, ZnSSe, ZnTe, ZnTeS, or ZnTeSe. In other embodiments, alloyed shells containing low levels of cadmium can also be used.

The thickness of the shell can be controlled by varying the amount of precursor provided. For a given shell thickness, at least one of the precursors is optionally provided in an amount whereby, when a growth reaction is substantially complete, a shell of a predetermined thickness is obtained. If more than one different precursor is provided, either the amount of each precursor can be limited or one of the precursors can be provided in a limiting amount while the others are provided in excess.

The thickness of each shell can be determined using techniques known to those of skill in the art. In some embodiments, the thickness of each shell is determined by comparing the average diameter of the nanostructure before and after the addition of each shell. In some embodiments, the average diameter of the nanostructure before and after the addition of each shell is determined by transmission electron microscopy. In some embodiments, each shell has a thickness of between 0.05 nm and 3.5 nm, between 0.05 nm and 2 nm, between 0.05 nm and 1 nm, between 0.05 nm and 0.5 nm, between 0.05 nm and 0.3 nm, between 0.05 nm and 0.1 nm, between 0.1 nm and 3.5 nm, between 0.1 nm and 2 nm, between 0.1 nm and 1 nm, between 0.1 nm and 0.5 nm, between 0.1 nm and 0.3 nm, between 0.3 nm and 3.5 nm, between 0.3 nm and 2 nm, between 0.3 nm and 1 nm, between 0.3 nm and 0.5 nm, between 0.5 nm and 3.5 nm, between 0.5 nm and 2 nm, between 0.5 nm and 1 nm, between 1 nm and 3.5 nm, between 1 nm and 2 nm, or between 2 nm and 3.5 nm.

In some embodiments, each shell is synthesized in the presence of at least one nanostructure ligand. Ligands can, e.g., enhance the miscibility of nanostructures in solvents or polymers (allowing the nanostructures to be distributed throughout a composition such that the nanostructures do not aggregate together), increase quantum yield of nanostructures, and/or preserve nanostructure luminescence (e.g., when the nanostructures are incorporated into a matrix). In some embodiments, the ligand(s) for the core synthesis and for the shell synthesis are the same. In some embodiments, the ligand(s) for the core synthesis and for the shell synthesis are different. Following synthesis, any ligand on the surface of the nanostructures can be exchanged for a different ligand with other desirable properties. Examples of ligands are disclosed in U.S. Pat. Nos. 7,572,395, 8,143,703, 8,425,803, 8,563,133, 8,916,064, 9,005,480, 9,139,770, and 9,169,435, and in U.S. Patent Application Publication No. 2008/0118755.

Ligands suitable for the synthesis of a shell are known by those of skill in the art. In some embodiments, the ligand is a fatty acid selected from the group consisting of lauric acid, caproic acid, myristic acid, palmitic acid, stearic acid, and oleic acid. In some embodiments, the ligand is an organic phosphine or an organic phosphine oxide selected from trioctylphosphine oxide (TOPO), trioctylphosphine (TOP), diphenylphosphine (DPP), triphenylphosphine oxide, and tributylphosphine oxide. In some embodiments, the ligand is an amine selected from the group consisting of dodecylamine, oleylamine, hexadecylamine, dioctylamine, and octadecylamine. In some embodiments, the ligand is tributylphosphine, oleic acid, or zinc oleate.

In some embodiments, each shell is produced in the presence of a mixture of ligands. In some embodiments, each layer of a shell is produced in the presence of a mixture comprising 2, 3, 4, 5, or 6 different ligands. In some embodiments, each shell is produced in the presence of a mixture comprising 3 different ligands. In some embodiments, the mixture of ligands comprises tributylphosphine, oleic acid, and zinc oleate.

In some embodiments, each shell is produced in the presence of a solvent. In some embodiments, the solvent is selected from the group consisting of 1-octadecene, 1-hexadecene, 1-eicosene, eicosane, octadecane, hexadecane, tetradecane, squalene, squalane, trioctylphosphine oxide, and dioctyl ether. In some embodiments, the solvent is 1-octadecene.

In some embodiments, a core or a core/shell(s) and shell materials are contacted at an addition temperature between 20° C. and 310° C., between 20° C. and 280° C., between 20° C. and 250° C., between 20° C. and 200° C., between 20° C. and 150° C., between 20° C. and 100° C., between 20° C. and 50° C., between 50° C. and 310° C., between 50° C. and 280° C., between 50° C. and 250° C., between 50° C. and 200° C., between 50° C. and 150° C., between 50° C. and 100° C., between 100° C. and 310° C., between 100° C. and 280° C., between 100° C. and 250° C., between 100° C. and 200° C., between 100° C. and 150° C., between 150° C. and 310° C., between 150° C. and 280° C., between 150° C. and 250° C., between 150° C. and 200° C., between 200° C. and 310° C., between 200° C. and 280° C., between 200° C. and 250° C., between 250° C. and 310° C., between 250° C. and 280° C., or between 280° C. and 310° C. In some embodiments, a core or a core/shell(s) and shell materials are contacted at an addition temperature between 20° C. and 100° C.

In some embodiments, after contacting a core or core/shell(s) and shell materials, the temperature of the reaction mixture is increased to an elevated temperature between 200° C. and 310° C., between 200° C. and 280° C., between 200° C. and 250° C., between 200° C. and 220° C., between 220° C. and 310° C., between 220° C. and 280° C., between 220° C. and 250° C., between 250° C. and 310° C., between 250° C. and 280° C., or between 280° C. and 310° C. In some embodiments, after contacting a core or core/shell(s) and shell materials, the temperature of the reaction mixture is increased to between 250° C. and 310° C.

In some embodiments, after contacting a core or core/shell(s) and shell materials, the time for the temperature to reach the elevated temperature is between 2 and 240 minutes, between 2 and 200 minutes, between 2 and 100 minutes, between 2 and 60 minutes, between 2 and 40 minutes, between 5 and 240 minutes, between 5 and 200 minutes, between 5 and 100 minutes, between 5 and 60 minutes, between 5 and 40 minutes, between 10 and 240 minutes, between 10 and 200 minutes, between 10 and 100 minutes, between 10 and 60 minutes, between 10 and 40 minutes, between 40 and 240 minutes, between 40 and 200 minutes, between 40 and 100 minutes, between 40 and 60 minutes, between 60 and 240 minutes, between 60 and 200 minutes, between 60 and 100 minutes, between 100 and 240 minutes, between 100 and 200 minutes, or between 200 and 240 minutes.

In some embodiments, after contacting a core or core/shell(s) and shell materials, the temperature of the reaction mixture is maintained at an elevated temperature for between 2 and 240 minutes, between 2 and 200 minutes, between 2 and 100 minutes, between 2 and 60 minutes, between 2 and 40 minutes, between 5 and 240 minutes, between 5 and 200 minutes, between 5 and 100 minutes, between 5 and 60 minutes, between 5 and 40 minutes, between 10 and 240 minutes, between 10 and 200 minutes, between 10 and 100 minutes, between 10 and 60 minutes, between 10 and 40 minutes, between 40 and 240 minutes, between 40 and 200 minutes, between 40 and 100 minutes, between 40 and 60 minutes, between 60 and 240 minutes, between 60 and 200 minutes, between 60 and 100 minutes, between 100 and 240 minutes, between 100 and 200 minutes, or between 200 and 240 minutes. In some embodiments, after contacting a core or core/shell(s) and shell materials, the temperature of the reaction mixture is maintained at an elevated temperature for between 30 and 120 minutes.

In some embodiments, additional shells are produced by further additions of shell material precursors that are added to the reaction mixture followed by maintaining at an elevated temperature. Typically, additional precursor is provided after reaction of the previous shell is substantially complete (e.g., when at least one of the previous precursors is depleted or removed from the reaction or when no additional growth is detectable). The further additions of precursor create additional shells.

In some embodiments, the nanostructure is cooled before the addition of additional shell material precursor to provide further shells. In some embodiments, the nanostructure is maintained at an elevated temperature before the addition of shell material precursor to provide further shells.

After sufficient layers of shell have been added for the nanostructure to reach the desired thickness and diameter, the nanostructure can be cooled. In some embodiments, the core/shell(s) nanostructures are cooled to room temperature. In some embodiments, an organic solvent is added to dilute the reaction mixture comprising the core/shell(s) nanostructures.

In some embodiments, the organic solvent used to dilute the reaction mixture is ethanol, hexane, pentane, toluene, benzene, diethylether, acetone, ethyl acetate, dichloromethane (methylene chloride), chloroform, dimethylformamide, or N-methylpyrrolidinone. In some embodiments, the organic solvent is toluene.

In some embodiments, the core/shell(s) nanostructures are isolated by precipitation using an organic solvent. In some embodiments, the core/shell(s) nanostructures are isolated by flocculation with ethanol.

### Production of a ZnSe Shell

In some embodiments, the shell deposited onto the core or core/shell(s) nanostructure is a ZnSe shell.

In some embodiments, the shell materials contacted with a core or core/shell(s) nanostructure to prepare a ZnSe shell comprise a zinc source and a selenium source.

In some embodiments, the zinc source is a dialkyl zinc compound. In some embodiments, the zinc source is a zinc carboxylate. In some embodiments, the zinc source is diethylzinc, dimethylzinc, zinc acetate, zinc acetylacetonate, zinc iodide, zinc bromide, zinc chloride, zinc fluoride, zinc carbonate, zinc cyanide, zinc nitrate, zinc oleate, zinc oxide, zinc peroxide, zinc perchlorate, zinc sulfate, zinc hexanoate, zinc octanoate, zinc laurate, zinc myristate, zinc palmitate, zinc stearate, zinc dithiocarbamate, or mixtures thereof. In some embodiments, the zinc source is zinc oleate, zinc hexanoate, zinc octanoate, zinc laurate, zinc myristate, zinc palmitate, zinc stearate, zinc dithiocarbamate, or mixtures thereof. In some embodiments, the zinc source is zinc oleate.

In some embodiments, the selenium source is an alkyl-substituted selenourea. In some embodiments, the selenium source is a phosphine selenide. In some embodiments, the selenium source is selected from trioctylphosphine selenide, tri(n-butyl)phosphine selenide, tri(sec-butyl)phosphine selenide, tri(tert-butyl)phosphine selenide, trimethylphosphine selenide, triphenylphosphine selenide, diphenylphosphine selenide, phenylphosphine selenide, tricyclohexylphosphine selenide, cyclohexylphosphine selenide, 1-octaneselenol, 1-dodecaneselenol, selenophenol, elemental selenium, hydrogen selenide, bis(trimethylsilyl) selenide, selenourea, and mixtures thereof. In some embodiments, the selenium source is tri(n-butyl)phosphine selenide, tri(sec-butyl)phosphine selenide, or tri(tert-butyl)phosphine selenide. In some embodiments, the selenium source is trioctylphosphine selenide.

In some embodiments, each ZnSe shell has a thickness of between 0.2 nm and 3.5 nm, between 0.2 nm and 2 nm, between 0.2 nm and 1 nm, between 0.2 nm and 0.5 nm, between 0.4 nm and 3.5 nm, between 0.4 nm and 2 nm, between 0.4 nm and 1 nm, between 0.6 nm and 3.5 nm, between 0.6 nm and 2 nm, between 0.6 nm and 1 nm, between 0.8 nm and 3.5 nm, between 0.8 nm and 2 nm, between 0.8 nm and 1 nm, between 1 nm and 3.5 nm, between 1 nm and 2 nm, or between 2 nm and 3.5 nm.

### Production of a ZnS Shell

In some embodiments, the shell deposited onto the core or core/shell(s) nanostructure is a ZnS shell.

In some embodiments, the shell materials contacted with a core or core/shell(s) nanostructure to prepare a ZnS shell comprise a zinc source and a sulfur source.

In some embodiments, the ZnS shell passivates defects at the particle surface, which leads to an improvement in the quantum yield and to higher efficiencies when used in devices such as LEDs and lasers. Furthermore, spectral impurities which are caused by defect states may be eliminated by passivation, which increases the color saturation.

In some embodiments, the zinc source is a dialkyl zinc compound. In some embodiments, the zinc source is a zinc carboxylate. In some embodiments, the zinc source is diethylzinc, dimethylzinc, zinc acetate, zinc acetylacetonate, zinc iodide, zinc bromide, zinc chloride, zinc fluoride, zinc carbonate, zinc cyanide, zinc nitrate, zinc oleate, zinc oxide, zinc peroxide, zinc perchlorate, zinc sulfate, zinc hexanoate, zinc octanoate, zinc laurate, zinc myristate, zinc palmitate, zinc stearate, zinc dithiocarbamate, or mixtures thereof. In some embodiments, the zinc source is zinc oleate, zinc hexanoate, zinc octanoate, zinc laurate, zinc myristate, zinc palmitate, zinc stearate, zinc dithiocarbamate, or mixtures thereof. In some embodiments, the zinc source is zinc oleate.

In some embodiments, the zinc source is produced by reacting a zinc salt with a carboxylic acid. In some embodiments, the carboxylic acid is selected from acetic acid, propionic acid, butyric acid, valeric acid, caproic acid, heptanoic acid, caprylic acid, capric acid, undecanoic acid, lauric acid, myristic acid, palmitic acid, stearic acid, behenic acid, acrylic acid, methacrylic acid, but-2-enoic acid, but-3-enoic acid, pent-2-enoic acid, pent-4-enoic acid, hex-2-enoic acid, hex-3-enoic acid, hex-4-enoic acid, hex-5-enoic acid, hept-6-enoic acid, oct-2-enoic acid, dec-2-enoic acid, undec-10-enoic acid, dodec-5-enoic acid, oleic acid, gadoleic acid, erucic acid, linoleic acid, α-linolenic acid, calendic acid, eicosadienoic acid, eicosatrienoic acid, arachidonic acid, stearidonic acid, benzoic acid, para-toluic acid, ortho-toluic acid, meta-toluic acid, hydrocinnamic acid, naphthenic acid, cinnamic acid, para-toluenesulfonic acid, and mixtures thereof.

In some embodiments, the sulfur source is selected from elemental sulfur, octanethiol, dodecanethiol, octadecanethiol, tributylphosphine sulfide, cyclohexyl isothiocyanate, α-toluenethiol, ethylene trithiocarbonate, allyl mercaptan, bis(trimethylsilyl) sulfide, trioctylphosphine sulfide, and mixtures thereof. In some embodiments, the sulfur source is an alkyl-substituted zinc dithiocarbamate. In some embodiments, the sulfur source is octanethiol.

In some embodiments, each ZnS shell has a thickness of between 0.2 nm and 3.5 nm, between 0.2 nm and 2 nm, between 0.2 nm and 1 nm, between 0.2 nm and 0.5 nm, between 0.4 nm and 3.5 nm, between 0.4 nm and 2 nm, between 0.4 nm and 1 nm, between 0.6 nm and 3.5 nm, between 0.6 nm and 2 nm, between 0.6 nm and 1 nm, between 0.8 nm and 3.5 nm, between 0.8 nm and 2 nm, between 0.8 nm and 1 nm, between 1 nm and 3.5 nm, between 1 nm and 2 nm, or between 2 nm and 3.5 nm.

### Core/Shell(s) Nanostructures

In some embodiments, the core/shell(s) nanostructure is a core/ZnSe/ZnS nanostructure. In some embodiments, the core/shell(s) nanostructure is a CdSe/ZnSe/ZnS nanostructure or an InP/ZnSe/ZnS nanostructure.

In some embodiments, the core/shell(s) nanostructures display a high photoluminescence quantum yield. In some embodiments, the core/shell(s) nanostructures display a photoluminescence quantum yield of between 60% and 99%, between 60% and 95%, between 60% and 90%, between 60% and 85%, between 60% and 80%, between 60% and 70%, between 70% and 99%, between 70% and 95%, between 70% and 90%, between 70% and 85%, between 70% and 80%, between 80% and 99%, between 80% and 95%, between 80% to 90%, between 80% and 85%, between 85% and 99%, between 85% and 95%, between 80% and 85%, between 85% and 99%, between 85% and 90%, between 90% and 99%, between 90% and 95%, or between 95% and 99%. In some embodiments, the core/shell(s) nanostructures display a photoluminescence quantum yield of between 85% and 96%.

The photoluminescence spectrum of the core/shell(s) nanostructures can cover essentially any desired portion of the spectrum. In some embodiments, the photoluminescence spectrum for the core/shell(s) nanostructures have a emission maximum between 300 nm and 750 nm, between 300 nm and 650 nm, between 300 nm and 550 nm, between 300 nm and 450 nm, between 450 nm and 750 nm, between 450 nm and 650 nm, between 450 nm and 550 nm, between 450 nm and 750 nm, between 450 nm and 650 nm, between 450 nm and 550 nm, between 550 nm and 750 nm, between 550 nm and 650 nm, or between 650 nm and 750 nm. In some embodiments, the photoluminescence spectrum for the core/shell(s) nanostructures has an emission maximum of between 500 nm and 550 nm. In some embodiments, the photoluminescence spectrum for the core/shell(s) nanostructures has an emission maximum of between 600 nm and 650 nm.

The size distribution of the core/shell(s) nanostructures can be relatively narrow. In some embodiments, the photoluminescence spectrum of the population or core/shell(s) nanostructures can have a full width at half maximum of between 10 nm and 60 nm, between 10 nm and 40 nm, between 10 nm and 30 nm, between 10 nm and 20 nm, between 20 nm and 60 nm, between 20 nm and 40 nm, between 20 nm and 30 nm, between 30 nm and 60 nm, between 30 nm and 40 nm, or between 40 nm and 60 nm. In some embodiments, the photoluminescence spectrum of the population or core/shell(s) nanostructures can have a full width at half maximum of between 35 nm and 45 nm.

In some embodiments, the core/shell(s) nanostructures are able to maintain high levels of photoluminescence intensity for long periods of time under continuous blue light exposure. In some embodiments, the core/shell(s) nanostructures are able to maintain 90% intensity (compared to the starting intensity level) of at least 2,000 hours, at least 4,000 hours, at least 6,000 hours, at least 8,000 hours, or at least 10,000 hours. In some embodiments, the core/shell(s) nanostructures are able to maintain 80% intensity (compared to the starting intensity level) of at least 2,000 hours, at least 4,000 hours, at least 6,000 hours, at least 8,000 hours, or at least 10,000 hours. In some embodiments, the core/shell(s) nanostructures are able to maintain 70% intensity (compared to the starting intensity level) of at least 2,000 hours, at least 4,000 hours, at least 6,000 hours, at least 8,000 hours, or at least 10,000 hours.

The relative molar ratios of core, ZnSe, and ZnS are calculated based on a spherical core of a given diameter by measuring the volumes, masses, and thus molar amounts of the desired spherical shells. For example, a green InP core of 1.8 nm diameter coated with ZnSe and ZnS requires 9.2 molar equivalents of ZnSe and 42.8 molar equivalents of ZnS relative to the molar amount of InP bound in the cores. This shell structure results in a total particle diameter of 6.23 nm. A green InP core of 1.8 nm diameter coated with ZnSe and ZnS provides a particle size with a measured mean particle diameter of 5.9 nm.

Coating the Nanostructures with an Oxide Material

Regardless of their composition, most nanostructures do not retain their originally high quantum yield after continuous exposure to excitation photons. Although the use of thick shells may prove effective in mitigating the effects of photoinduced quantum yield deterioration, the photodegradation of nanostructures may be further retarded by encasing them with an oxide. Coating nanostructures with an oxide causes their surface to become physically isolated from their environments.

Coating nanostructures with an oxide material has been shown to increase their photostability. In Jo, J.-H., et al., J. Alloys & Compounds 647:6-13 (2015), InP/ZnS red-emitting nanostructures were overcoated with an oxide phase of In₂O₃ which was found to substantially alleviate nanostructure photodegradation as shown by comparative photostability results.

In some embodiments, the nanostructures are coated with an oxide material for increased stability. In some embodiments, the oxide material is In₂O₃, SiO₂, Al₂O₃, or TiO₂.

Nanostructure Premix

The coating system requires that nanostructures be rapidly dispersible in resin matrix and requires a homogeneous nanostructure composition prior to coating. However, when mixing nanostructures and resins, the nanostructures undergo a change in environment from the nanostructure concentrate to the resin matrix, and nanostructure surface ligands must come to a new equilibrium. In some cases, the nanostructures first undergo a period of colloidal instability where agglomerates form and then return to colloidal stability (a new equilibrium). In cases where the nanostructure equilibration time in resin exceeds the formulation's dwell time from mixing to coating, the nanostructures may not be fully dispersed by the time the mixture exits the die. When this happens, the nanostructures are cured in the QDEF as agglomerates and exhibit poor optical properties. To solve the aggregation problem, the nanostructures are premixed with resins to form a nanostructure premix prior to being delivered into the mixing apparatus.

### Resins

In some embodiments, the nanostructure premix comprises at least one population of nanostructures and at least one organic resin.

A wide variety of suitable resin polymers is known to those of skill in the art (see e.g., Dietrich Demus, John W. Goodby, George W. Gray, Hans W. Spiess, and Volkmar Vill (1998) Handbook of Liquid Crystals, Handbook of Liquid Crystals: Four Volume Set, John Wiley and Sons, Inc.; Johannes Brandrup (1999) Polymer Handbook, John Wiley and Sons, Inc.; and Charles A. Harper (2002) Handbook of Plastics, Elastomers, and Composites, 4th edition, McGraw-Hill). Examples include thermoplastic polymers (e.g., polyolefins, polyesters, polysilicones, polyacrylonitrile resins, polystyrene resins, polyvinyl chloride, polyvinylidene chloride, polyvinyl acetate, or fluoroplastics); thermosetting polymers (e.g., phenolic resins, urea resins, melamine resins, epoxy resins, polyurethane resins); engineering plastics (e.g., polyamides, polyacrylate resins, polyketones, polyimides, polysulfones, polycarbonates, polyacetals); and liquid crystal polymers, including main chain liquid crystal polymers (e.g., poly(hydroxynapthoic acid)) and side chain liquid crystal polymers (e.g., poly [n-((4′(4″-cyanphenyl)phenoxy)alkyl)vinyl ether]). Certain embodiments include conductive organic polymers; see e.g. T. A. Skatherin (ed.) Handbook of Conducting Polymers I. Examples include but are not limited to poly(3-hexylthiophene)(P3HT), poly[2-methoxy, 5-(2′-ethyl-hexyloxy)-p-phenylene-vinylene] (MEH-PPV), poly(phenylene vinylene)(PPV), and polyaniline. In some embodiments, the resin comprises tricyclodecane dimethanol diacrylate, pentaerythritol tetrakis(3-mercaptopropionate), trimethylolpropane tris(3-mercaptopropionate), tris[2-(3-mercaptopropionyloxy)ethyl]isocyanurate, ethylene glycol diethanethiol, glycol di(3-mercaptopriopionate), triallyl triazine trione, tris[2-(acryloyloxy)ethyl]isocyanurate, cyclohexane dimethanol di(meth)acrylate, hexanediol di(meth)acrylate, butanediol di(meth)acrylate, trimethanolpropane tri(meth)acrylate, pentaerythritol tetra(meth)acrylate, triallyl cyanurate, trivinylcyclohexane, pentaerythritol allyl ether, cyclohexanedimethanol divinyl ether, butanediol divinyl ether, isobornyl (meth)acrylate, lauryl(meth)acrylate, bisphenol A ethoxylate di(meth)acrylate, 2-carboxyethyl (meth)acrylate, 2-hydroxyethyl (meth)acrylate, 2-((meth)acryloyloxy)ethyl phosphate, furfuryl (meth)acrylate, or oligomerization products thereof.

The resin polymers can be provided in various forms. For example, in one embodiment, the resin polymer(s) are soluble in the at least one solvent (e.g., polyacrylic acid in water, or PVDF in acetone). In another embodiment, the polymer(s) comprise oligomers that are soluble in the solvent. In this embodiment, the composition can further comprise at least one cross-linking agent (e.g., a cross-linker and/or a catalyst, for cross-linking the oligomers after the composition has been applied to a surface). In yet another embodiment, the polymer(s) comprise emulsion polymerized polymer particles that are dispersed in the at least one solvent. In this embodiment, the composition can further comprise at least one glue agent, for example, a polymer, a photoinitiator or cross-linking agent. Emulsion polymerized particles of various polymers are commercially available; for example, emulsions of polyolefins and polyacrylates are available from Air Products and Chemicals, Inc. (www.airproducts.com). The size of available polymer particles is typically in the range of about 10 nm to about 200 nm.

The at least one solvent can be essentially any convenient solvent, for example, water or an organic solvent (e.g., an alcohol, a ketone, an acetate, an amine, a diol, a glycol, or a glycol ether). The solvent concentration can be adjusted to control the viscosity of the blank resin and nanostructure premix to render it suitable for roll printing application to essentially any desired substrate.

The composition can optionally further comprise at least one surfactant (e.g., a cationic, anionic, or nonionic surfactant) to assist in dispersal of the particles of the composite material and/or at least one humectant (e.g., a glycol, a diol, a sulfoxide, a sulfone, an amide, or an alcohol).

The solvent concentration can be adjusted to adjust the viscosity of the blank resin and the nanostructure premix to render it suitable for roll printing application to essentially any desired substrate. The nanostructure composition can also comprise a viscosity modifier.

In some embodiments, the blank resin and nanostructure premixes have a viscosity between about 1 cps and about 1,000,000 cps at about 25° C., or between about 100 cps and about 25,000 cps at about 25° C., or between about 1,000 cps and about 10,000 cps at about 25° C., or between about 10,000 cps and about 25,000 cps at about 25° C. In some embodiments, the blank resin and nanostructure premixes have a viscosity between about 50 cps and about 1,000 cps at about 25° C. In some embodiments, the blank resin and nanostructure premixes are solid at 25° C. In other embodiments, the blank resin and nanostructure premixes have a viscosity between about 1 cps and about 1,000,000 cps at about 150° C. to 225° C., or between about 100 cps and about 25,000 cps at about 150° C. to 225° C., or between about 1,000 cps and about 10,000 cps at about 150° C. to 225° C., or between about 10,000 cps and about 25,000 cps at about 150° C. to 225° C. In some embodiments, the blank resin and nanostructure premixes have a viscosity between about 50 cps and about 1,000 cps at about 150° C. to 225° C.

### Equipment and Methods to Prepare Films and Adjust White Point

A system was developed to make adjustments to the white point of a nanostructure film in real time during the coating process. By metering the blank resin, red nanostructure premix, and green nanostructure premix independently through an in-line mixing apparatus, the white point of the nanostructure film can be adjusted on-the-fly. A spectrometer in-line with the coating web allows real-time analysis of the film's white point during coating. Combining real-time optical analysis of the film with the ability to adjust the metering rates of the red nanostructure premix, and the green nanostructure premix allows the white point to be dialed in without the need for several formulation trials.

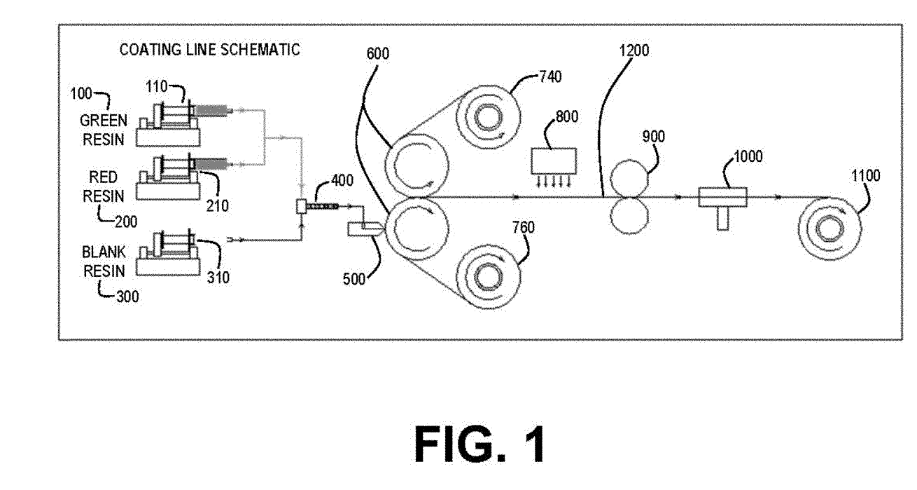

An exemplary coating line system of the present invention is illustrated in FIG. 1. The green nanostructure premix 100, red nanostructure premix 200 and blank resin 300, each is fed by individual metering pumps 110, 210, and 310, combined in a mixing apparatus 400 to form a nanostructure composition. The nanostructure composition passes through a slot dye applicator 500 prior to entry onto the 2 roll coating module 600, and is then coated on the substrate film 1200, wherein the thickness of the nanostructure composition is controlled by setting the gap between the 2 roll coating module 600. The nanostructure composition moves through the system in one direction, generally from unwind rolls, comprising a top unwind 740 and a bottom unwind 760 to wind roll 1100. After exiting 2 roll coating module 600, the nanostructure composition passes through UV cure lamp 800 and is cured into a solid nanostructure film. Then the cured nanostructure film passes through a pull roll module 900 and then a spectrometer 1000 which detects and analyzes the optical properties of the nanostructure film for comparison to a target value. Corrective output signals may be transmitted to the individual metering pumps 110, 210, and 310, to adjust the flow rate of green nanostructure premix 100, red nanostructure premix 200 and blank resin 300. Alternatively, the flow rate can be adjusted manually based on the analysis of collected data and the target value. In some embodiments, the optical property is optical density, emission wavelengths, FWHM, white point, and brightness. In one embodiment, the optical property is white point of the nanostructure film.

In some embodiments, the metering pump is a syringe pump, a gear pump or other similar fluid metering device known in the art. In some embodiments, a programmable automatic syringe pump is used to ensure a constant delivery rate. In some embodiments, the fluid is pushed from a pressure pot using compressed gas while the flow rate is controlled by a flow control valve.

In some embodiments, the mixing apparatus is a static mixer (e.g., commercially available from National Oilwell Varco, StaMixCo LLC, and Fluitec Georg AG), a micromixer (e.g., commercially available from Dolomite Microfluidics, Blacktrace Holdings Ltd.), a close-clearance mixer (e.g., commercially available from Chongqing Tianhe Electric Tech Co.), a high shear disperser (e.g., commercially available from Charles Ross & Son Co.), a liquid whistle (e.g., commercially available from Sonic Corp.), a mix-Itometer (e.g., commercially available from Industrial Tomography Systems plc.), a high viscosity mixer (e.g., commercially available from Hockmeyer Equipment Corp.), a submersible mixer (e.g., commercially available from Sulzer Ltd.), a dispersion mixer (e.g., commercially available from Cole-Parmer Instrument Co.), a planetary mixer (e.g., commercially available from Charles Ross & Son Co.) or other suitable mixing apparatus known in the art.

In some embodiments, the spectrometer is capable of measuring an ultraviolet-visible light and fluorescence.

In some embodiments, the coating line comprises tubes that connect different parts, for example, metering pumps, mixing apparatus, and slot die applicator. While this invention is not intended to be limited to specific values for the diameter and length of the tube, the optimal values of these dimensions will be determined by considerations of the viscosity of the nanostructure composition and blank resin and the pressure drop needed to drive the nanostructure composition and blank resin through the tube, all of which will depend on the concentration of the nanostructures in nanostructures composition, resin polymer components, temperature, and other parameters. The optimal dimensions can be determined by routine experimentation, or by the use of relationships that are well known among those skilled in fluid dynamics. In one embodiment, the tubes have an internal diameter of about 1.5 mm to 9 mm, or within the range of about 3 mm to about 6 mm. In another embodiment, the tubes have an internal diameter of about 5 mm to 30 mm, or within the range of about 10 mm to about 20 mm.

### Films, Devices and Uses

The film may be used in production of a nanostructure phosphor, and/or incorporated into a device, e.g., an LED, backlight, downlight, or other display or lighting unit or an optical filter. Exemplary phosphors and lighting units can, e.g., generate a specific color light by incorporating a population of nanostructures with an emission maximum at or near the desired wavelength or a wide color gamut by incorporating two or more different populations of nanostructures having different emission maxima. A variety of suitable matrices are known in the art. See, e.g., U.S. Pat. No. 7,068,898 and U.S. Patent Application Publication Nos. 2010/0276638, 2007/0034833, and 2012/0113672. Exemplary nanostructure phosphor films, LEDs, backlighting units, etc. are described, e.g., in U.S. Patent Application Publications Nos. 2010/0276638, 2012/0113672, 2008/0237540, 2010/0110728, 2010/0155749, and 2017/0250322 and U.S. Pat. Nos. 7,374,807, 7,645,397, 6,501,091, and 6,803,719.

In one embodiment, the at least one first population of cadmium-containing core-shell nanostructures and the at least one second population of core-shell nanostructures are combined with a matrix and manufactured into an optical film. In one embodiment, the first population of cadmium-containing core-shell nanostructures are CdSe/ZnSe/ZnS and the at least one second population of core-shell nanostructures is InP/ZnSe/ZnS. The optical film may be used in a commercial display to give a color gamut as a percentage of the Rec.2020 space of at least 80% and RoHS compliance. In another embodiment, the color gamut of the optical film as a percentage of the Rec.2020 space is about 85-98%.

The display device may comprise:

(a) a layer that emits radiation;

(b) an optical film layer comprising the at least one first and second populations of nanostructures, disposed on the radiation emitting layer;

(c) an optically transparent barrier layer on the optical film layer; and

(d) an optical element, disposed on the barrier layer.

In one embodiment, the radiation emitting layer, the optical film layer, and the optical element are part of a pixel unit of the display device. In another embodiment, the optical element is a color filter. In another embodiment, the barrier layer comprises an oxide. In another embodiment, the film layer further comprises surfactants or ligands bonded to the optically transparent barrier layer. In another embodiment, the optically transparent barrier layer is configured to protect the nanostructure from degradation by light flux, heat, oxygen, moisture, or a combination thereof.

### EXAMPLES

The following examples are illustrative and non-limiting, of the products and methods described herein. Suitable modifications and adaptations of the variety of conditions, formulations, and other parameters normally encountered in the field and which are obvious to those skilled in the art in view of this disclosure are within the spirit and scope of the invention.

The following sets forth a series of examples that demonstrate methods of producing quantum dot compositions and quantum dot films, adjusting white point of the quantum dot films in a continuous process, and an apparatus of for preparing a quantum dot film for real-time white point adjustment.

### Example 1: Preparation of Quantum Dot Premix and Blank Resin

A quantum dot premix contains the same components as a blank resin with the addition of quantum dot concentrate(s) in isobornyl acrylate (IBOA). The quantum dot premix and the blank resin were prepared according to the following procedure: titanium dioxide (TiO₂), tricyclodecane dimethanol diacrylate (TCDD), 4-hydroxy-2,2,6,6-tetramethylpiperidin-1-oxyl (4-hydroxy-TEMPO), pentaerythritol tetrakis(3-mercaptopropionate) (PTMP), ethyl(2,4,6-Trimethylbenzoyl)-phenyl phosphinate (TPO-L) and optionally, acetic acid, were weighed in a mixing container and mixed at 2000 RPM for 5 minutes in a planetary vacuum mixer until the powders were dispersed and the mixture was homogenous. For the quantum dot premix, green and red quantum dot concentrates were further added to the mixture and mixed at 2000 RPM for 2 minutes. The quantum dot premix and the blank resin were allowed to age for 24 hours and remixed at 2000 RPM for 2 minutes in a planetary vacuum mixer within 1 hour before coating. The materials used to prepare the blank resin and the quantum dot premix are shown in Table 1. The formulation of the blank resin, the green quantum dot premix, and the red quantum dot premix is shown in Table 2.

TABLE 1
Materials used to prepare blank resin and premix

| | | Product | |
|---|---|---|---|
| Material | Supplier | # | CAS# |
| Titanium Dioxide | Chemours | R-706 | 13463-67-7 |
| Acetic Acid | Sigma Aldrich | 695092 | 64-19-7 |
| Tricyclodecane Dimethanol | Sartomer | SR833s | 42594-17-2 |
| Diacrylate | | | |
| 4-Hydroxy-TEMPO | Sigma Aldrich | 176141 | 2226-96-2 |
| Pentaerythritol tetrakis | Evans | PETMP | 7575-23-7 |
| (3-mercaptopropionate) | Chemetics | | |
| 2-Propenoic acid, 2-methyl, | Sigma Aldrich | 291811 | 142-90-5 |
| dodecyl ester | | | |
| Quantum Dot Concentrate in | Nanosys | | 1776097- |
| Isobornyl Acrylate | | | 03-0 |
| Ethyl(2,4,6-Trimethylbenzoyl)- | Omnirad | TPO-L | 84434-11-7 |
| phenyl phosphinate | | | |

TABLE 2
Formulation of Blank Resin, Green Quantum Dot Premix, and Red
Quantum Dot Premix

| | | Green | Red |
|---|---|---|---|
| | | Quantum | Quantum |
| | Blank | Dot | Dot |
| | Resin | Premix | Premix |
| Titanium Dioxide (g) | 1.013 | 0.338 | 0.338 |
| Tricyclodecane Dimethanol | 108.000 | 36.000 | 36.000 |
| Diacrylate (g) | | | |
| 4-Hydroxy-TEMPO (g) | 0.0135 | 0.0045 | 0.0045 |
| Pentaerythritol tetrakis(3- | 27.000 | 9.000 | 9.000 |
| mercaptopropionate) (g) | | | |
| Acetic Acid (ml) | 0.000 | 3.803 | 3.128 |
| Ethyl(2,4,6-Trimethylbenzoyl)- | 0.3375 | 0.1125 | 0.1125 |
| phenyl phosphinate (g) | | | |
| Green Quantum Dot Concentrate | 0.000 | 7.674 | 0.000 |
| in Isobornyl Acrylate (ml) | | | |
| Red Quantum Dot Concentrate | 0.000 | 0.000 | 6.061 |
| in Isobornyl Acrylate (ml) | | | |

### Example 2: In-Line Mixing and White Point Adjustment

A red quantum dot premix, green quantum dot premix, and blank resin were prepared for in-line mixing. Formulation of red and green quantum dot premixes eliminates the problems caused by lack of dwell time between quantum dots integration and curing. Red and green quantum dot premixes were formulated well ahead of coating time. Testing was conducted off-line, ensuring that the quantum dots were fully dispersed before the coater was brought on-line for continuous coating and white-point targeting. Blank resin consisted of TCDD, PTMP, TiO₂, TPO-L, and 4-hydroxy-TEMPO. A premix contained the same components as the blank resin with the addition of quantum dot concentrate(s) in IBOA. The formulation of the blank resin, the green quantum dot premix, and the red quantum dot premix is shown in Table 3.

TABLE 3
Formulation of Blank Resin, Green Quantum Dot Premix, and Red
Quantum Dot Premix

| | 3-Part Premix Trial | | |
|---|---|---|---|
| Formulation | A | B | C |
| Green LE OD-450 (OD/ml) | 45.20 | 45.20 | 45.20 |
| Red LE OD-450 (OD/ml) | 51.60 | 51.60 | 51.60 |
| Green target OD-450 | 0 | 4.225 | 0 |
| Red target OD-450 | 0 | 0 | 3.475 |
| Mass (g) | 45 | 90 | 90 |
| PTMP wt fraction | 0.2 | 0.2 | 0.2 |
| TiO2 target (%) | 0.75% | 0.75% | 0.75% |
| TPO target (%) | 0.50% | 0.50% | 0.50% |
| HyT Target (ppm) | 100 | 100 | 100 |
| Acetic Acid (ul/OD) | 10 | 10 | 10 |
| TiO2 (g) | 0.338 | 0.675 | 0.675 |
| TCDD (g) | 31.500 | 63.000 | 63.000 |
| TCDD w/1000 ppm HyT (g) | 4.500 | 9.000 | 9.000 |
| PTMP (g) | 9.000 | 18.000 | 18.000 |
| Acetic Acid (ml) | 0.000 | 3.803 | 3.128 |
| Green vol (ml) | 0.000 | 8.413 | 0.000 |
| Red vol (ml) | 0.000 | 0.000 | 3.061 |
| TPO-L (g) | 0.225 | 0.45 | 0.45 |

The equipment for coating comprises a syringe pump (Harvard Apparatus 703010 and Chemyx Nexus 6000), a static mixer (Stamixco GXF-10-12), a spectrometer (Ocean Optics USB2000), and a roll-to-roll coating line. After full dispersion was confirmed, the red quantum dot premix, the green quantum dot premix, and the blank resin were loaded into syringe pumps, and pushed through a static mixer by syringe pumps before exiting a slot die onto a substrate moving on a roll-to-roll coating line.

The roll-to-roll coating line consisted of two unwinds feeding films to a two-roll coating module such that the mixed quantum dot composition was metered between the two films. The thickness of the quantum dot composition was controlled by setting the gap between the two coating rollers. Subsequently, the laminated film containing the quantum dot composition was passed through an ultraviolet cure area to cure the quantum dot composition into a solid film. Next, the solid film exited through a pull roll module that gripped the solid film between a motor driven roller and another roller, and then passed through a spectrometer to determine the white point. Data from the spectrometer was used to make appropriate adjustments, either automatically or manually, to the flow rates of one or more formulation parts in order to achieve the desired white point in film. Lastly the film was either wound up or cut into sheets. A schematic of coating line is shown in FIG. 1.

### Example 3: Relationship Between Reliability and Dispersion

The system requires that quantum dots be rapidly dispersible in the resin matrix. Dwell time of the full formulation is between 60 to 120 seconds, from the point of injection and mixing until exiting the die head of the coater. As quantum dots undergo a change in environment from the quantum dot concentrate to the resin matrix, quantum dot surface ligands must come to a new equilibrium. In some cases, the quantum dots undergo a period of colloidal instability where agglomerates form.

Agglomeration can be temporary and reversible. As ligands reorient on the quantum dot surface, agglomerates are broken apart and colloidal stability returns. This process may take anywhere from minutes to days depending on the chemistries involved. To study and characterize the effect of dispersion of quantum dots and reliability of the film, two quantum dot premixes with different levels of dispersion were prepared and the optical property was characterized. In preparation of Sample 1, the quantum dots equilibration time in resin exceeded the formulation's dwell time from mixing to coating, therefore the quantum dots were not fully dispersed by the time the mixture exited the die and later cured in the enhancement film as agglomerates. In preparation of Sample 2, the quantum dots were fully dispersed before coating onto substrates. The formulation of the two quantum dot premixes is shown in Table 4.

TABLE 4
Quantum Dot Premixes Formulation

| | Sample | |
|---|---|---|
| | 1 | 2 |
| Pentaerythritol tetrakis(3-mercaptopropionate) (g) | 4 | 4 |
| Tricyclodecane Dimethanol Diacrylate (g) | 16 | 16 |
| 4-Hydroxy-TEMPO (g) | 0.002 | 0.002 |
| Ethyl(2,4,6-Trimethylbenzoyl)-phenyl phosphinate (g) | 0.2 | 0.2 |
| Titanium Dioxide (g) | 0.15 | 0.15 |
| Green Quantum Dot Concentrate in Isobornyl | 0.752 | 0.599 |
| Acrylate (ml) | | |
| Red Quantum Dot Concentrate in Isobornyl | 0.471 | 0.471 |
| Acrylate (ml) | | |

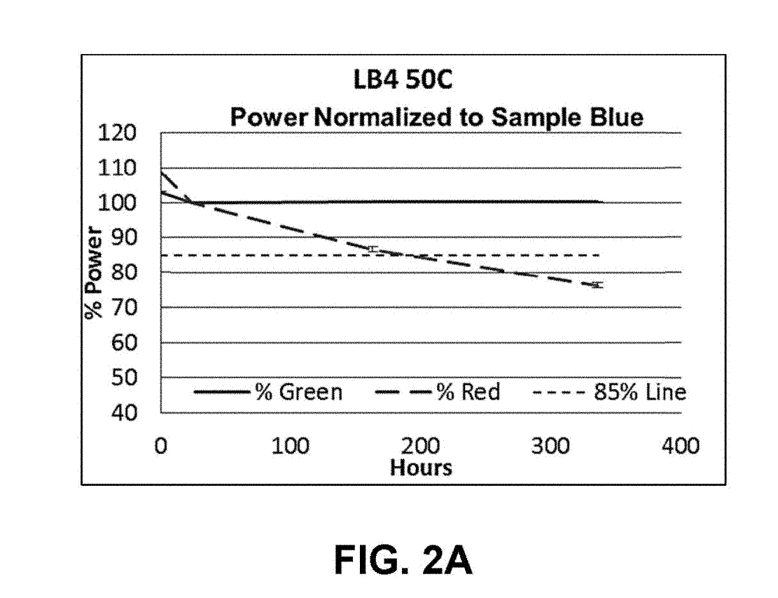

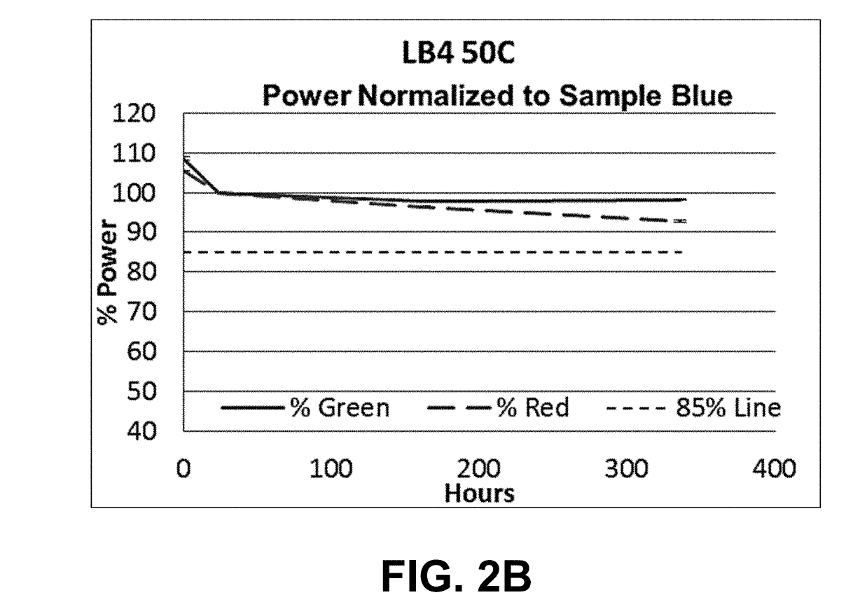

As shown in Table 5 and FIG. 2, the film with poorly dispersed quantum dots (Sample 1) exhibited longer red peak emission wavelength, higher wavelength and reduced flux reliability and degraded conversion efficiency.

TABLE 5
Quantum Dot Premixes with Different Dispersion

| | | Film Green | Film | Film | Film |
|---|---|---|---|---|---|
| | Conversion | peak | Green | Red peak | Red |
| Sample | Efficiency | wavelength | FWHM | wavelength | FWHM |
| 1 | 64.9% | 529.03 | 18.92 | 642.97 | 40.29 |
| 2 | 68.4% | 529.58 | 19.14 | 639.47 | 40.84 |

Having now fully described this invention, it will be understood by those of ordinary skill in the art that the same can be performed within a wide and equivalent range of conditions, formulations and other parameters without affecting the scope of the invention or any embodiment thereof. All patents, patent applications, and publications cited herein are fully incorporated by reference herein in their entirety.

1. A method of preparing a nanostructure composition, comprising:
(a) providing at least two nanostructure premixes, wherein each nanostructure premix comprising at least one population of nanostructures and at least one organic resin;
(b) continuously delivering the at least two nanostructure premixes to a mixing apparatus to give a nanostructure composition;
(c) coating the nanostructure composition onto a substrate to make a nanostructure film;
(d) continuously monitoring an optical property of the nanostructure film; and
(e) adjusting the quantity of the at least two nanostructure premixes delivered to the mixing apparatus thereby adjusting the optical property of the nanostructure film.

2. (canceled)

3. The method of claim 1, wherein the at least one population of nanostructures and the at least one organic resin are premixed to make the nanostructure premix prior to the continuously delivering in (b).

4. (canceled)

5. (canceled)

6. The method of claim 1, wherein the at least two nanostructure premixes comprises a red nanostructure premix and a green nanostructure premix.

7. The method of claim 6, wherein the at least two nanostructure premixes further comprises a blue nanostructure premix.

8. The method of claim 1, wherein the nanostructure premix comprises between one and five populations of nanostructures.

9. The method of claim 1, wherein the at least one population of nanostructures contain a core selected from the group consisting of InP and CdSe.

10. The method of claim 1, wherein the nanostructures are core/shell nanostructures.

11. The method of claim 10, wherein the core/shell nanostructures are CdSe/ZnSe/ZnS or InP/ZnSe/ZnS nanostructures.

12. The method of claim 1, wherein the at least one organic resin comprises between one and five organic resins.

13. The method of claim 1, wherein the at least one organic resin comprises tricyclodecane dimethanol diacrylate, pentaerythritol tetrakis(3-mercaptopropionate), trimethylolpropane tris(3-mercaptopropionate), tris[2-(3-mercaptopropionyloxy)ethyl]isocyanurate, ethylene glycol diethanethiol, glycol di(3-mercaptopriopionate), triallyl triazine trione, tris[2-(acryloyloxy)ethyl]isocyanurate, cyclohexane dimethanol di(meth)acrylate, hexanediol di(meth)acrylate, butanediol di(meth)acrylate, trimethanolpropane tri(meth)acrylate, pentaerythritol tetra(meth)acrylate, triallyl cyanurate, trivinylcyclohexane, pentaerythritol allyl ether, cyclohexanedimethanol divinyl ether, butanediol divinyl ether, isobornyl (meth)acrylate, lauryl (meth)acrylate, bisphenol A ethoxylate di(meth)acrylate, 2-carboxyethyl(meth)acrylate, 2-hydroxyethyl (meth)acrylate, 2-((meth)acryloyloxy)ethyl phosphate, furfuryl (meth)acrylate, or oligomerization products thereof.

14. The method of claim 1, wherein the nanostructure premix further comprises a surfactant, a solvent, a humectant, or a viscosity modifier.

15. The method of claim 1, wherein the optical property is white point, color gamut, optical density, emission wavelengths, FWHM, and/or brightness.

16. The method of claim 15, wherein the optical property is white point.

17. The method of claim 1, wherein the optical property is monitored with a spectrometer.

18. The method of claim 1, wherein the nanostructures are quantum dots.

19. An apparatus for preparing a nanostructure film, comprising:
(a) a mixing apparatus;
(b) at least two input ports fluidly connected to the mixing apparatus;
(c) a coating system; and
(d) an instrument that measures an optical property of the nanostructure film.

20. (canceled)

21. (canceled)

22. (canceled)

23. The apparatus of claim 19, wherein the at least two input ports are flow controlled.

24. The apparatus of claim 19, wherein the mixing apparatus is a static mixer.

25. (canceled)

26. The apparatus of claim 19, wherein the instrument that measures an optical property of the nanostructure film is a spectrometer.

27. The apparatus of claim 26, wherein the spectrometer is capable of measuring ultraviolet-visible light.
